(19) United States
(12) Patent Application Publication
(10) Pub. No.: US 2012/0166237 A1
(43) Pub. Date: Jun. 28, 2012

(54) METHOD OF PREDICTING PRODUCTIVITY OF EMBROIDERING MACHINE, METHOD OF MANAGING PRODUCTIVITY AND METHOD OF ANALYZING RETURN OF INVESTMENT AND MACHINE RESIDUAL VALUE USING THE SAME, AND RECORDING MEDIUM FOR STORING PROGRAM FOR PERFORMING METHOD OF PREDICTING PRODUCTIVITY OF EMBROIDERING MACHINE

(75) Inventor: Seoung Ill OH, Incheon (KR)

(73) Assignee: SUNSTAR CO., LTD., Incheon (KR)

(21) Appl. No.: 13/337,399

(22) Filed: Dec. 27, 2011

(30) Foreign Application Priority Data
Dec. 28, 2010 (KR) 10-2010-0136604
Jul. 13, 2011 (KR) 10-2011-0069519

(51) Int. Cl. G06Q 10/04

(52) U.S. Cl. 705/7.11

(57) ABSTRACT

A method of predicting expected work contents based on the analysis of an embroidery design, and a method of managing productivity and method of analyzing the return of investment and machine residual value using the method are provided.

In the method of predicting productivity of an embroidering machine, basic work information such as a total number of stitches for an embroidery design, a number of times a thread is trimmed, a number of changes in a color of a thread, and a size of the embroidery design is analyzed. Expected work information that is predicted in order for an embroidering machine to produce the embroidery design is calculated based on the analyzed basic work information.

### CROSS REFERENCE TO RELATED APPLICATION

This application claims the benefit under 35 U.S.C. 119(a) of Korean Patent Application Nos. 10-2010-0136604, filed on Dec. 28, 2010, and 10-2011-0069519, filed on Jul. 13, 2011, the disclosure of each of which is incorporated by reference in its entirety for all purposes.

### BACKGROUND OF THE INVENTION

1. Field of the Invention

The present invention relates, in general, to a method of managing the productivity of an embroidering machine and, more particularly, to a method of predicting expected work contents based on the analysis of an embroidery design, a method of managing productivity and a method of analyzing the return of investment and machine residual value using the method, and a recording medium for storing a program for performing the method of predicting the productivity of the embroidering machine.

2. Description of the Related Art

An embroidering machine is configured such that after sewing fabric is fixed using an embroidery frame, a predetermined embroidery design is formed on the sewing fabric.

There have been made attempts to enhance productivity by improving the structure of an embroidering machine or bettering an embroidery process. These conventional methods were intended to efficiently do predetermined work or to smoothly perform the connection between processes.

For example, Korean Patent Laid-Open Publication No. 10-2008-0089249 (published on Oct. 6, 2008) discloses a scheme in which variations in the number of completions of sewing per unit time is recorded and the contents of pieces of work in individual processes are analyzed, thus smoothly performing the task of connecting the individual processes.

However, technology for analyzing an embroidery design input to an embroidering machine and then predicting or managing productivity has not yet been developed.

Further, there has not yet been proposed a method of comparing production costs per stitch by comparing expenses invested in the production of embroidery goods, and of consequently comparing or determining the performances of embroidering machines or of evaluating the return of investment and machine residual value based on the results of the comparison or determination of the performances of embroidering machines.

### SUMMARY OF THE INVENTION

Accordingly, the present invention has been made keeping in mind the above problems occurring in the prior art, and an object of the present invention is to provide a method of predicting productivity for each embroidery design.

Another object of the present invention is to provide a method of managing productivity using the productivity prediction method.

A further object of the present invention is to provide a method of analyzing the return of investment and machine residual value using the productivity prediction method.

Yet another object of the present invention is to provide a computer-readable recording medium for storing the method of predicting productivity for each embroidery design.

In order to accomplish the above objects, the present invention provides a method of predicting productivity of an embroidering machine, including analyzing basic work information such as a total number of stitches for an embroidery design, a number of times a thread is trimmed, a number of changes in a color of a thread, and a size of the embroidery design; and calculating expected work information that is predicted in order for an embroidering machine to produce the embroidery design based on the analyzed basic work information.

Preferably, the expected work information may include at least one of a maximum Revolution Per Minute (RPM) of a main shaft, hook size, an expected number of times a thread is broken, time required in case of thread breakage, consumption of an upper thread, a number of bobbins consumed, a number of designs that can be arranged in a workspace, expected work time, and an expected output.

Further, in order to accomplish the above objects, the present invention provides a method of managing productivity of an embroidering machine, including analyzing basic work information such as a total number of stitches for an embroidery design, a number of times a thread is trimmed, a number of changes in a color of a thread, and a size of the embroidery design, and calculating expected work information that is predicted in order for an embroidering machine to produce the embroidery design based on the analyzed basic work information; obtaining actual work information that is actually required by applying the embroidery design to a work process; and comparing the expected work information with the actual work information, and modifying the embroidery design or updating the expected work information with reference to results of the comparison.

Preferably, the expected work information may include a maximum Revolution Per Minute (RPM) of a main shaft, hook size, an expected number of times a thread is broken, time required in case of thread breakage, consumption of an upper thread, a number of bobbins consumed, a number of designs that can be arranged in a workspace, expected work time, and an expected output.

Furthermore, in order to accomplish the above objects, the present invention provides a method of analyzing return of investment and machine residual value, including inputting fixed expenses, maintenance cost, real investment cost, and expected work information related to an embroidery design; and evaluating return of investment and machine residual value based on the fixed expenses, the maintenance cost, the real investment cost, and the expected work information related to the embroidery design.

Preferably, the expected work information related to the embroidery design may include total time required to produce the relevant embroidery design, a total number of stitches for head unit work, a number of stitches per hour, and loss time of work attributable to replacement of an embroidery frame.

Furthermore, the present invention provides a method of predicting productivity of an embroidering machine, including analyzing basic work information such as a total number of stitches for an embroidery design, a number of times a thread is trimmed, a number of changes in a color of a thread, and a size of the embroidery design; and calculating expected work information that is predicted in order for an embroidering machine to produce the embroidery design based on the analyzed basic work information.

Furthermore, in order to accomplish the above objects, the present invention provides a computer-readable recording medium for storing a program for performing a method of predicting productivity for each embroidery design, the program including analyzing basic work information such as a total number of stitches for an embroidery design, a number of times a thread is trimmed, a number of changes in a color of a thread, and a size of the embroidery design; and calculating expected work information that is predicted in order for an embroidering machine to produce the embroidery design based on the analyzed basic work information.

Preferably, the computer-readable recording medium may further include comparing the expected work information with actual work information, which is obtained by applying the embroidery design to an actual work process, and updating the expected work information with reference to results of the comparison.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of a screen for displaying the productivity prediction information of an embroidering machine according to the present invention;

FIG. 2 is a flowchart showing a method of predicting the productivity of an embroidering machine and a method of managing productivity using the productivity prediction method according to the present invention;

FIG. 3 is a diagram showing a relationship between a workspace and a design that can be waned in the workspace;

FIG. 4 is a diagram showing a method of analyzing the return of investment and machine residual value according to the present invention;

FIG. 5 is a diagram showing an example of a screen for evaluating machine residual value;

FIG. 6 is a diagram showing a basic setup information screen for establishing fixed expenses;

FIG. 7 is a diagram showing a screen for establishing real investment costs;

FIG. 8 is a diagram showing an example of a screen for comparing the productivity of individual embroidering machines;

FIG. 9 is a diagram showing an example of a screen for establishing maintenance costs;

FIG. 10 is a diagram showing an example of a screen for analyzing the return of investment and residual value;

FIG. 11 is a flowchart showing a method of analyzing the return of investment and machine residual value according to the present invention; and

FIG. 12 illustrates an example of a screen for displaying the productivity prediction information of an embroidering machine on a smart phone according to the present invention.

### DESCRIPTION OF THE PREFERRED EMBODIMENTS

Hereinafter, the construction and operation of the present invention will be described in detail with reference to the attached drawings.

In the present invention, basic work information refers to information essentially required to form a design itself or embroider the design. For example, the total number of stitches (the total stitches) for a relevant embroidery design, the number of times a thread is trimmed (trim times), the number of changes in the color of a thread, the size of the embroidery design, etc. may correspond to the basic work information.

Even if work is done for the same design, work times, outputs, etc. may inevitably differ among embroidering machines, and conform to the inherent characteristics of the respective embroidering machines.

In the present invention, expected work information refers to information based on the characteristics of respective embroidering machines, and may include the maximum rotation speed of a main shaft (Maximum Revolution Per Minute: Max. RPM), the hook size, the expected number of times a thread is broken (thread breakage times), the time required in case of thread breakage, the consumption of an upper thread, the number of bobbins consumed, the number of designs that can be arranged in a workspace, expected work time, an expected output, etc.

Expected work information refers to either information that can be applied on average to the same kind of embroidering machine or expected values obtained from such information. In contrast, actual work information refers to information that is obtained from contents actually worked by applying an embroidery design to an embroidering machine. There may be differences between expected work information and the actual work information because of various unpredictable factors such as environmental factors and seasonal factors.

On the other hand, the expected work information may be updated by adaptively or statistically applying such actual work information.

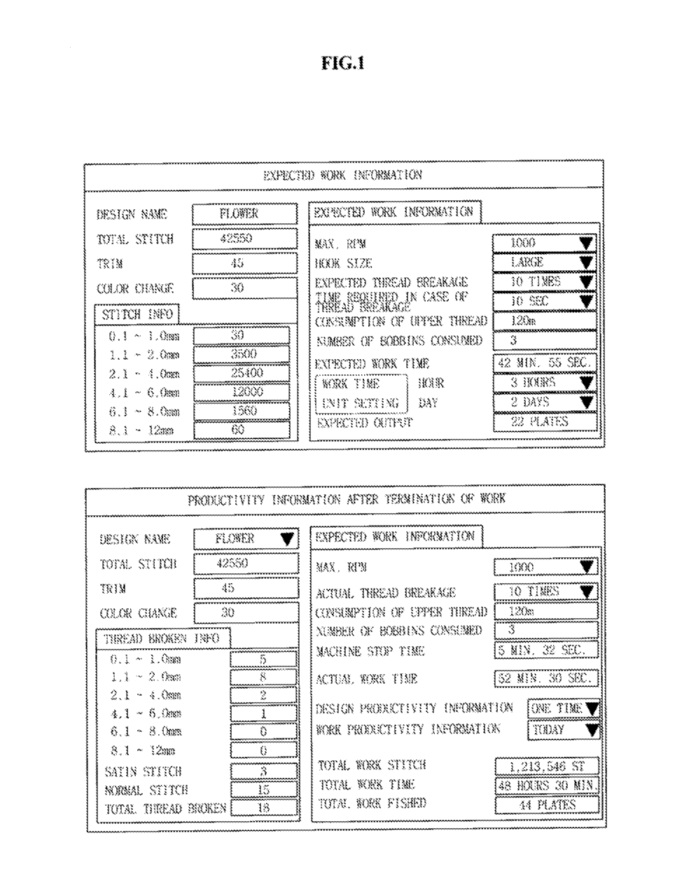

FIG. 1 is a diagram showing an example of a screen for displaying the productivity prediction information of an embroidering machine according to the present invention. This screen appears when a design to be worked is selected from an operator screen before work begins, and shows pieces of the expected work information that are predicted for respective designs, thus allowing the operator to predict productivity. The screen shown in FIG. 1 may be a screen on a Personal Computer (PC) or a smart phone.

Referring to a window for “expected work information”, basic work information is displayed on the upper left portion of the window, stitch information is displayed on the lower left portion of the window, and expected work information is displayed on the right portion of the window. The items of the basic work information are implemented to display a design name, the total number of stitches (the total stitches) for a relevant design, the number of times a thread is trimmed (trim), the number of changes in the color of a thread (color change), the size of an embroidery design, etc. Referring to the items of stitch information, the numbers of stitches for respective lengths are displayed.

The items of the expected work information are implemented to display the maximum RPM of a main shaft (Max. RPM), the hook size, the expected number of times a thread is broken, the time required in case of thread breakage, the consumption of an upper thread, the number of bobbins consumed, expected work time, an expected output, etc.

The meanings of the respective input items are defined as follows.

“Expected work information”
Max. RPM: Max. RPM values for respective types are set. Work times based on the total stitches are obtained using multiple RPM values.
Hook size: the sizes of hooks for respective types are set (normal, large).
The expected number of times a thread is broken: the expected number of times a thread is broken is input, and is then used as an input value for an expected work time.
Time required in case of thread breakage: the unit of the time for which an operator changes a thread when a thread is broken is measured.
Consumption of upper thread (m): the consumption of an upper thread is measured by measuring the length of stitches within a relevant design.
The number of bobbins consumed: the number of bobbins consumed (changed) is measured by measuring the length of the stitches within a relevant design.
Expected work time: expected work time is calculated in consideration of various types of work conditions.
The setting of the unit of work time: the unit of work is set based on the expected work time, and then an expected output is calculated.
Expected output the expected output is calculated in consideration of various types of work conditions.

“Actual thread breakage information”

This shows information about actual thread breakage information for each stitch width and each stitch generation condition, so that the frequency of thread breakage can be detected, and the productivity can be improved using the modification of a design.

The actual number of times a thread is broken: the actual number of times a thread is broken is counted, and is then used as an input value for work time.

Machine stop time: this indicates the time for which a machine stops during working. This time is not included in actual work time.

Actual work time: this actual work time is calculated in consideration of various types of work conditions.

Design productivity information: information about the productivity that is applied one time/the total number of times depending on designs is displayed.

Work productivity information: information about productivity of all contents having worked up to today/current time is displayed.

Referring to a window for “productivity information after the termination of work”, the contents of the analysis of work activity performed to produce a designated design are presented.

Referring to a field for expected work information in the window for “productivity information after the termination of work”, actual maximum RPM of a main shaft (Max. RPM), the actual number of times a thread is broken, the consumption of an upper thread, the number of bobbins consumed, machine stop time, actual work time, design productivity information, work productivity information, etc. are displayed.

By comparing the expected work information items of the window for “expected work information” with the expected work information items of the window for “productivity information after the termination of work”, a relevarit design may be modified or expected work information may be updated so that productivity can be improved.

Further, in accordance with the method of predicting the productivity of the embroidering machine according to the present invention, a user can predict productivity based on a work design by referring to the expected work information before beginning work.

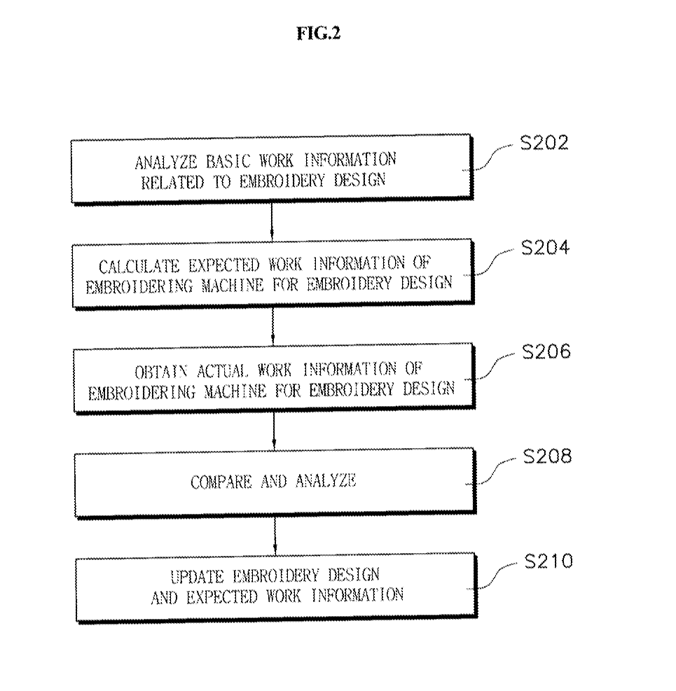

FIG. 2 is a flowchart showing a method of predicting the productivity of an embroidering machine and a method of managing productivity using the productivity prediction method according to the present invention.

First, an embroidery design to be produced is analyzed, so that the productivity of the embroidering machine for an embroidery design is predicted at steps S202 and S204.

In detail, basic work information related to the embroidery design, such as the total number of stitches (the total stitches), the number of times a thread is trimmed, the number of changes in the color of a thread, and the size of the relevant embroidery design, is analyzed at step S202.

Then, expected work information which is predicted to be required in order for the embroidering machine to produce the relevant embroidery design is calculated based on the analyzed basic work information at step S204.

The expected work information includes the maximum RPM of a main shaft (Max. RPM), the hook size, the expected number of times a thread is broken, the time required in case of thread breakage, the consumption of an upper thread, the number of bobbins consumed, the number of designs that can be arranged in a workspace, expected work time, an expected output, etc. The above steps S202 and S204 correspond to a method of predicting productivity for each design in the summary of the present invention.

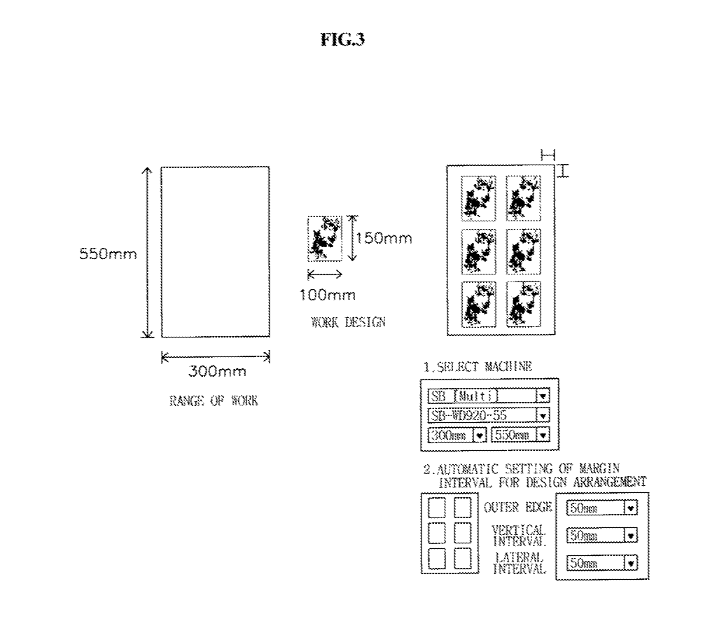

FIG. 3 illustrates a relationship between a workspace and a design that can be arranged in the workspace. The workspace of the embroidering machine is determined by the interval at which the heads are arranged, the number of heads, etc., and has a unique value for each embroidering machine. For example, in the case of a multi-head embroidering machine, when a head interval is 300 mm, the length of the workspace is limited to 300 mm.

As shown in FIG. 3, the size of the workspace is 550 mm×300 mm, and the size of a design to be worked is 150 mm×100 mm, six designs can be arranged in the workspace.

However, when designs are arranged in the workspace, margins for marking and cutting must be provided, and thus a margin interval for design arrangement must preferably be taken into consideration. The margin interval for design arrangement may be designated by default or manually.

Work information actually required when the embroidery design is formed on sewing fabric using the embroidering machine is obtained at step S206.

The expected work information is compared to the actual work information that is required actually at step S208.

The embroidery design is modified or the expected work information is updated with reference to the results of the comparison at step S210. Modifying the embroidery design includes changes in the design itself and its replacement with another design. Here, steps S206 to S210 may correspond to the method of managing productivity for each embroidery design in the summary of the present invention.

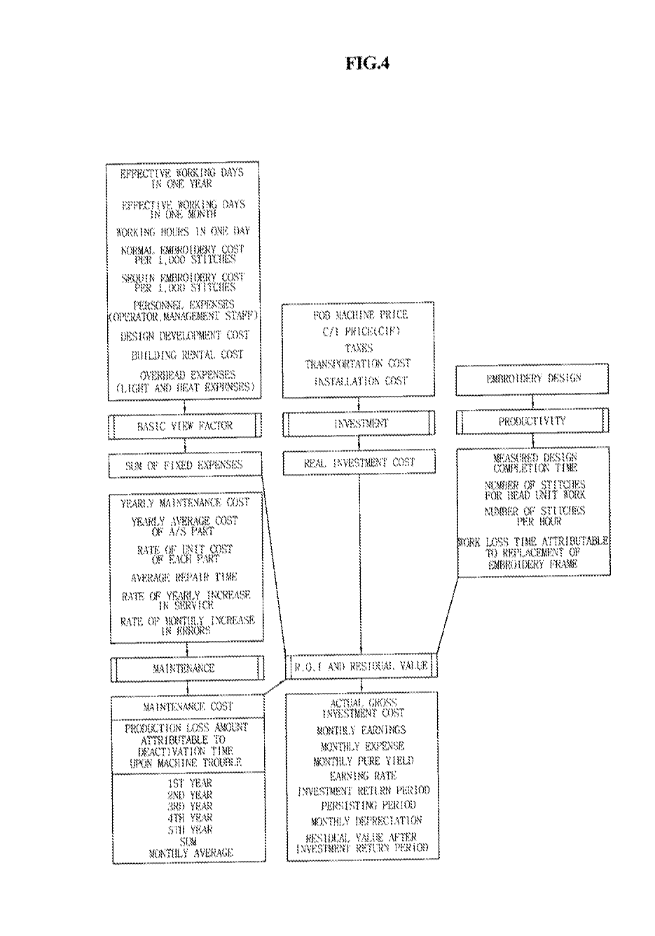

FIG. 4 illustrates a method of analyzing the return of investment and machine residual value according to the present invention. Referring to FIG. 4, the method of analyzing the return of investment and machine residual value according to the present invention is configured to input fixed expenses, maintenance cost, real investment cost, and expected work information related to an embroidery design, and to analyze the return of investment and machine residual value on the basis of the input information.

Fixed expenses include effective working days (yearly, monthly), work time in one day, normal embroidery cost per 1,000 stitches, sequin embroidery cost per 1,000 stitches, personnel expenses (operator, management staff), design development cost, building rental cost, and overhead expenses (light and heat expenses, etc.).

Maintenance cost includes yearly maintenance cost, yearly average cost of an After/Service (A/S) part, the rate of unit cost of each part, the average repair time, the rate of a yearly increase in service, the rate of a monthly increase in errors, etc.

Real investment cost includes a machine price, taxes, transportation cost, installation cost, etc.

Expected work information related to an embroidery design includes the total work time required to produce the relevant design, the total number of stitches for head unit work, the number of stitches per hour, the loss time of work attributable to the replacement of an embroidery frame, etc.

For this function, the expected work information related to the embroidery design is analyzed.

In detail, basic work information for a relevant embroidery design, such as the total stitches, the number of times a thread is trimmed (trim times), the number of changes in the color of a thread (color change), and the size of the embroidery design, is analyzed. Expected work information which is predicted to be required in order for the embroidering machine to produce the relevant design is calculated based on the analyzed basic work information.

The expected work information includes the maximum RPM of a main shaft (Max. RPM), the hook size, the expected number of times a thread is broken, the time required in case of thread breakage, the consumption of an upper thread, the number of bobbins consumed, the number of designs that can be arranged in a workspace, the expected work time, an expected output, etc.

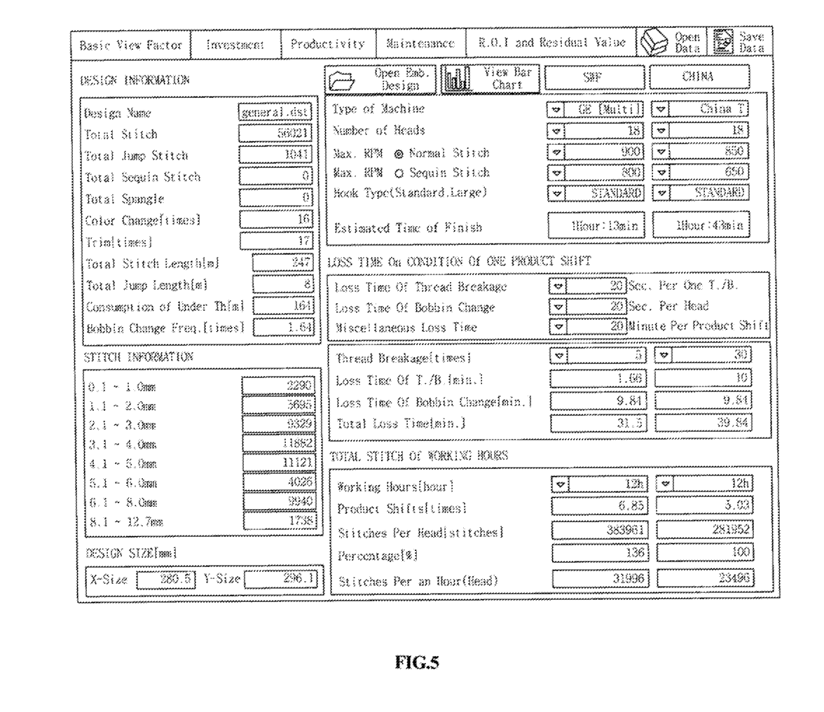

FIG. 5 illustrates an example of a screen for evaluating machine residual value. Referring to FIG. 5, for a given design, the results of the comparison and evaluation of embroidery products produced by two kinds of machines are shown.

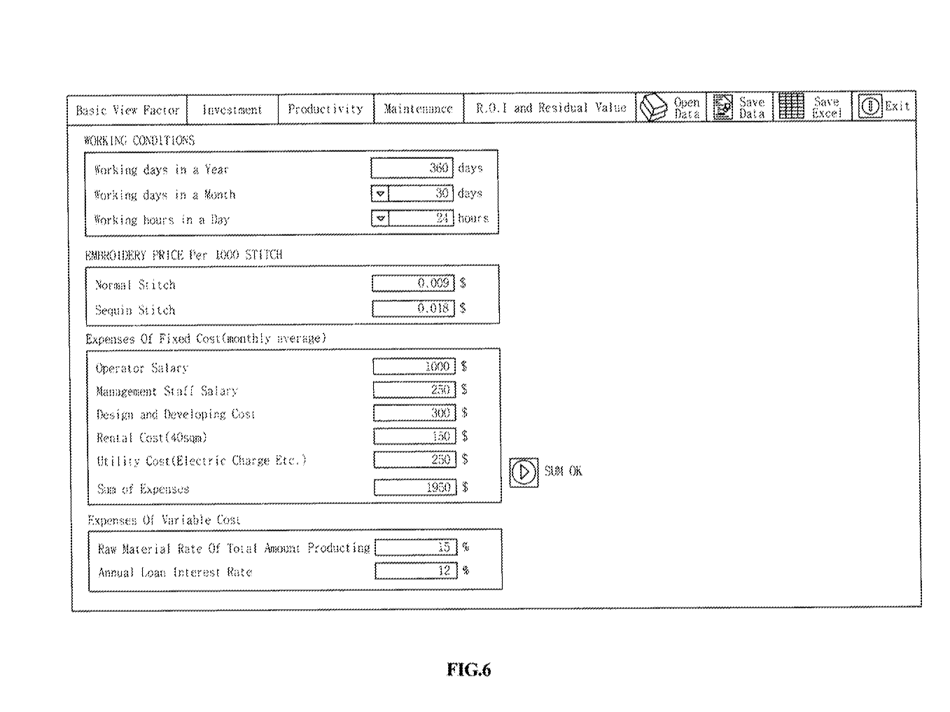

FIG. 6 illustrates a basic setup information screen for establishing fixed expenses. This basic setup information screen may be used to input working days (yearly, monthly), working hours in one day, embroidery cost per 1,000 stitches (normal, sequin), personnel expenses (operator, management staff), design development cost, building rental cost, overhead expenses (utility costs such as light and heat expenses).

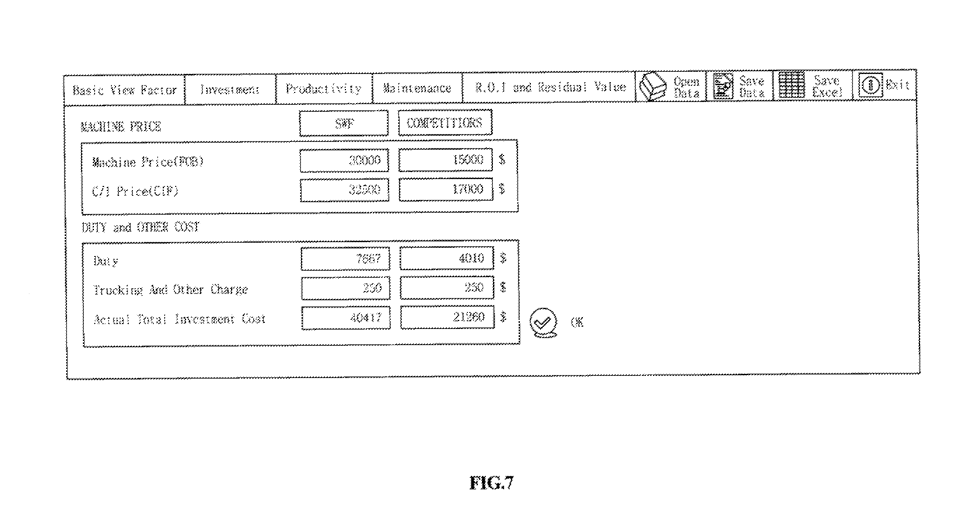

FIG. 7 illustrates a screen for establishing real investment cost. Such a real investment cost establishment screen may be used to input a machine price, taxes, transportation cost, installation cost, etc.

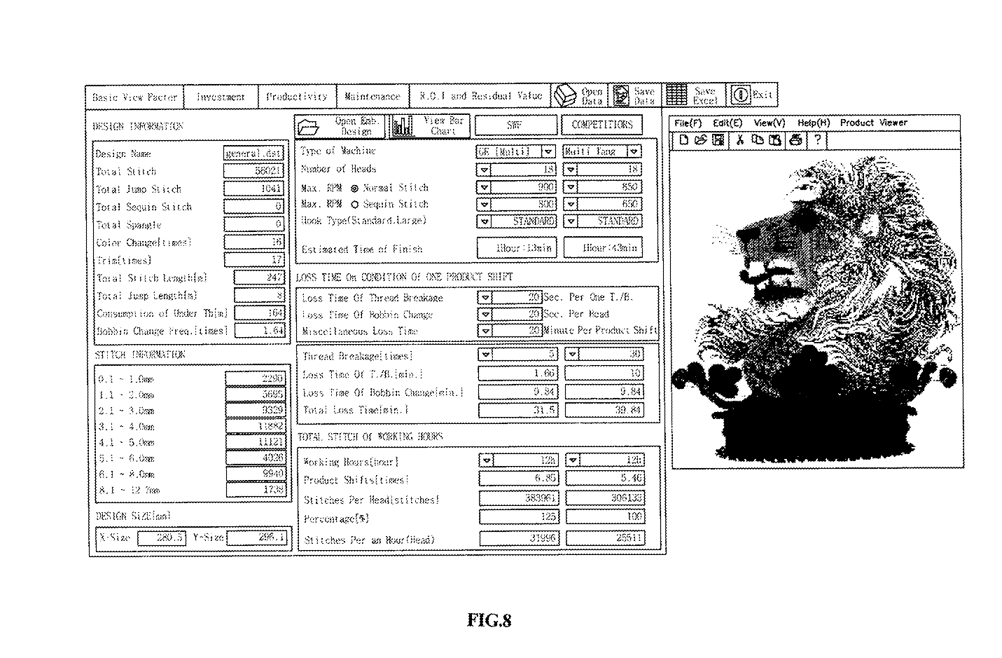

FIG. 8 illustrates an example of a screen for comparing the productivity of individual embroidering machines. A design that is a reference for comparison is displayed on the right side of FIG. 8, and basic parameters required to produce the relevant design are displayed using design information items on the left side of the drawing. At the center portion of the screen, the results of comparing and evaluating contents required to produce the relevant design using two embroidery products produced by two kinds of machines are displayed.

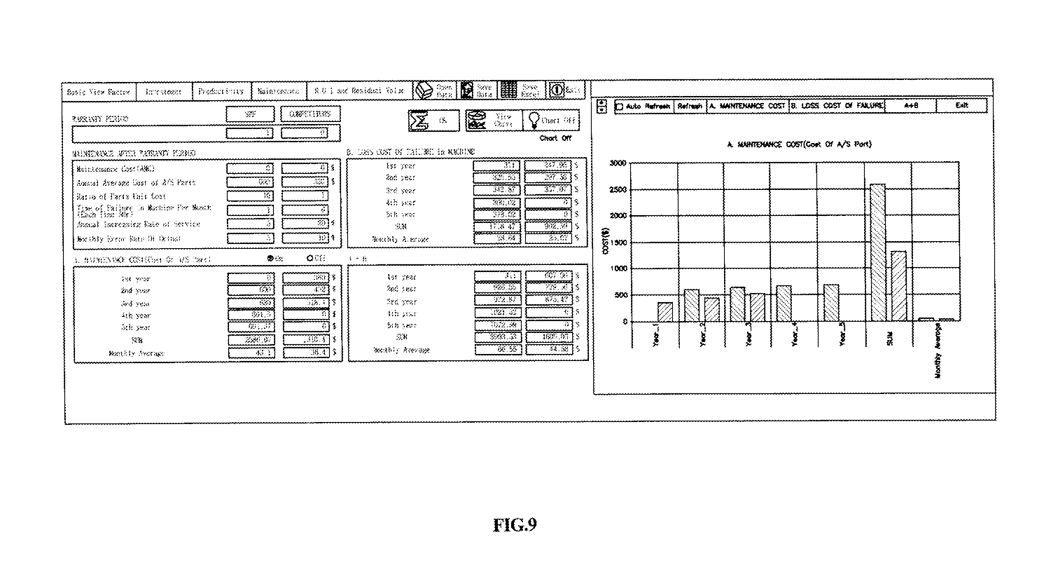

FIG. 9 illustrates an example of a screen for establishing maintenance cost. Such a maintenance cost establishment screen may be used to input, change, update, or compare yearly maintenance cost, the yearly average cost of an A/S part, the rate of unit cost of each part, the average repair time, the rate of a yearly increase in service, the rate of a monthly increase in errors, etc.

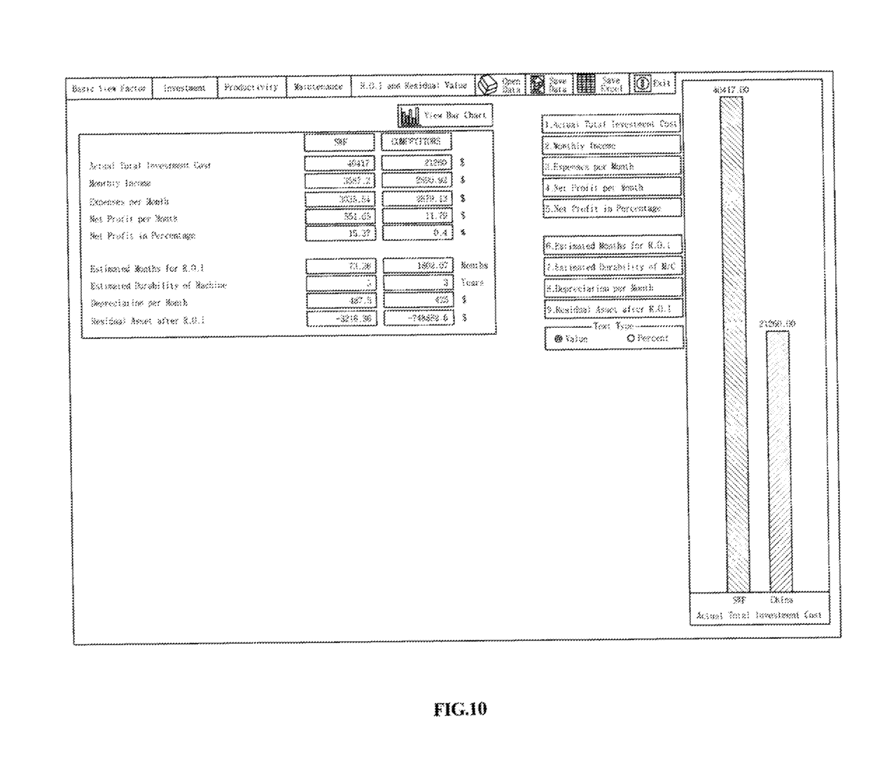

FIG. 10 illustrates an example of a screen for analyzing the return of investment and residual value. The screen shown in FIG. 10 may be used to compare and evaluate the return of investment (ROI) and residual value.

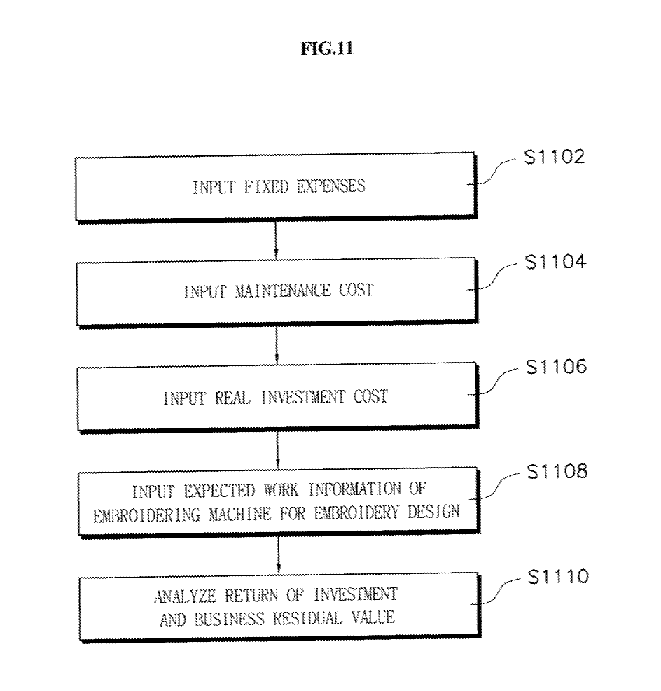

FIG. 11 is a flowchart showing a method of analyzing the return of investment and machine residual value according to the present invention.

Basic factors required to calculate fixed expenses are input at step S1102.

The fixed expenses includes effective working days (yearly, monthly), work time in one day, normal embroidery cost per 1,000 stitches, sequin embroidery cost per 1,000 stitches, personnel expenses (operator, management staff), design development cost, building rental cost, and overhead expenses (light and heat expenses, etc.).

Factors required to calculate maintenance cost are input at step S1104.

The maintenance cost includes yearly maintenance cost, yearly average cost of an A/S part, the rate of unit cost of each part, the average repair time, the rate of a yearly increase in service, the rate of a monthly increase in errors, etc.

Factors required to calculate real investment cost are input at step S1106.

The real investment cost includes a machine price, taxes, transportation cost, installation cost, etc.

The expected work information related to the embroidery design is input at step S1108.

The expected work information related to the embroidery design includes the total time required to complete the design, the total number of stitches for head unit work, the number of stitches per hour, the loss time of work attributable to the replacement of an embroidery frame, etc.

The return of investment and residual value are evaluated based on the fixed expenses, maintenance cost, real investment cost, and embroidery design information at step S1110.

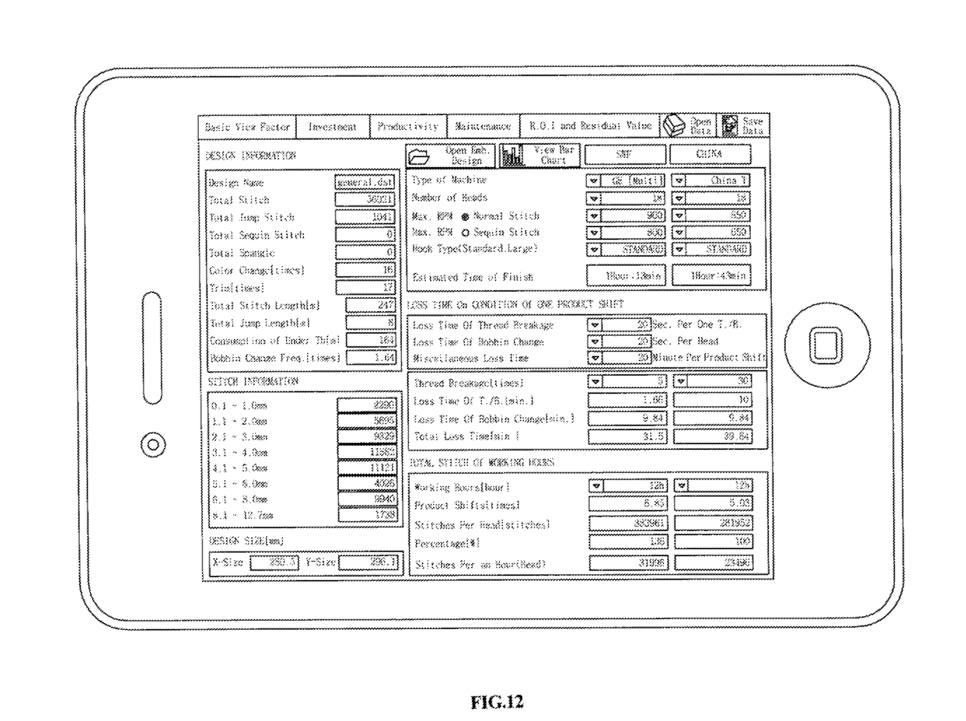

FIG. 12 illustrates an example of a screen for displaying the productivity prediction information of an embroidering machine on a smart phone according to the present invention.

The present invention may adopt the form of an embodiment including only hardware, an embodiment including only software, or an embodiment including both hardware and software elements. In the presented embodiment, the present invention is implemented in software including, not limited to, firmware, resident software, or microcode.

Further, the present invention may adopt the form of a computer program product that is accessible by a computer-usable or computer-readable medium that is to be used either by a computer or any instruction execution system or together with this system.

For this purpose, the computer-usable or computer-readable medium may be any substantial device capable of including, storing, communicating, transferring or carrying the program so that the medium can be used by or together with the command execution system, apparatus or device.

The method of predicting the productivity of an embroidering machine according to the present invention may be implemented in the form of program instructions that can be executed using various types of computer means and may be stored on a computer-readable medium. The computer-readable medium may include program instructions, data files, data structures, etc. independently or in combination. The program instructions stored on the medium may be designed especially for the present invention or may also be known to and be used by those skilled in the art of computer software.

The device for implementing the program stored on the computer-readable recording medium according to the present invention may be any of a PC, a smart phone, a Personal Digital Assistant (PDA), a notebook computer, a netbook computer, a tablet PC, and a mobile phone. In the present invention, such a device is not limited to the above-described examples, and any of the devices can be used as long as they are capable of implementing the program stored on the computer-readable recording medium. For example, a smart phone for implementing the program stored on the computer-readable recording medium of the present invention is configured as a hardware system having a single platform, and may include a Central Processing Unit (CPU), a storage device (memory), a display device, an input device, an audio input/output device composed of a microphone and a receiver or a speaker, an antenna, etc.

Examples of the computer-readable recording medium include magnetic media such as a hard disk, a floppy disk, and magnetic tape, optical media such as Compact Disk-Read Only Memory (CD-ROM) and a Digital Versatile Disk (DVD), magneto-optical media such as a floptical disk, and hardware devices such as ROM, Random Access Memory (RAM), and flash memory that are especially configured to store and execute program instructions.

The medium may be a transfer medium such as light, a metal wire or a waveguide including carrier waves for transmitting signals required to designate program instructions or data structures. Examples of program instructions include not only machine language code created by a compiler, but also high-level language code that can be executed by computers using an interpreter or the like. The above hardware devices may be configured to function as one or more software modules so as to perform the operations of the present invention, and vice versa.

As described above, although the present invention has been described with reference to limited embodiments and drawings, the present invention is not limited to the above embodiments, and those skilled in the art will appreciate that various changes and modifications are possible from the above description.

Therefore, the scope of the present invention should not be limited by the above-described embodiments, and should be defined by the accompanying claims and equivalents thereof.

In accordance with the method of analyzing the return of investment and machine residual value according to the present invention, state information based on the productivity of a machine is input; and the residual value of the machine compared to that of a rival company is detected, thus maximizing management characteristics and improving competitive power at the sales point of a relevant company.

As described above, in accordance with the method of managing the productivity of an embroidering machine according to the present invention, productivity can be predicted and managed based on the expected work information for producing an embroidery design, thus enabling the productivity of the embroidering machine to be effectively managed.

Further, in accordance with the method of predicting the productivity of an embroidering machine according to the present invention, there is an advantage in that embroidery designs or a process for producing the embroidery designs can be improved with reference to the expected work information and the actual work information related to embroidery designs.

Furthermore, in accordance with the method of analyzing the return of investment and machine residual value according to the present invention, state information based on the productivity of a machine is input, and the residual value of the machine compared to that of a rival company is detected, thus maximizing management characteristics and improving competitive power at the sales point of a relevant company.

What is claimed is:

1. A method of predicting productivity of an embroidering machine, comprising:
analyzing basic work information such as a total, number of stitches for an embroidery design, a number of times a thread is trimmed, a number of changes in a color of a thread, and a size of the embroidery design; and
calculating expected work information that is predicted in order for an embroidering machine to produce the embroidery design based on the analyzed basic work information.

2. The method according to claim 1, wherein the expected work information comprises at least one of a maximum Revolution Per Minute (RPM) of a main shaft, hook size, an expected number of times a thread is broken, time required in case of thread breakage, consumption of an upper thread, a number of bobbins consumed, expected work time, and an expected output

3. The method according to claim 2, wherein the expected work information further comprises a number of designs that can be arranged in a workspace.

4. The method according to claim 2, wherein the expected work information further comprises a number of designs that can be arranged in a workspace, and a margin interval for arrangement of the designs.

5. A method of managing productivity of an embroidering machine, comprising:
analyzing basic work information such as a total number of stitches for an embroidery design, a number of times a thread is trimmed, a number of changes in a color of a thread, and a size of the embroidery design, and calculating expected work information that is predicted in order for an embroidering machine to produce the embroidery design based on the analyzed basic work information;
obtaining actual work information that is actually required by applying the embroidery design to a work process; and
comparing the expected work information with the actual work information, and modifying the embroidery design or updating the expected work information with reference to results of the comparison.

6. The method according to claim 5, wherein each of the expected work information and the actual work information comprises at least one of a maximum Revolution Per Minute (RPM) of a main shaft, hook size, an expected number of times a thread is broken, time required in case of thread breakage, consumption of an upper thread, a number of bobbins consumed, a number of designs that can be arranged in a workspace, expected work time, and an expected output.

7. A method of analyzing return of investment and machine residual value, comprising:
inputting fixed expenses, maintenance cost, real investment cost, and expected work information related to an embroidery design; and
evaluating return of investment and machine residual value based on the fixed expenses, the maintenance cost, the real investment cost, and the expected work information related to the embroidery design.

8. The method according to claim 7, wherein the expected work information related to the embroidery design comprises at least one of total time required to produce the relevant embroidery design, a total number of stitches for head unit work, a number of stitches per hour, and loss time of work attributable to replacement of an embroidery frame.

9. A computer-readable recording medium for storing a program for performing a method of predicting productivity for each embroidery design, the program comprising:
analyzing basic work information such as a total number of stitches for an embroidery design, a number of times a thread is trimmed, a number of changes in a color of a thread, and a size of the embroidery design; and
calculating expected work information that is predicted in order for an embroidering machine to produce the embroidery design based on the analyzed basic work information.

10. The computer-readable recording medium according to claim 9, further comprising:
comparing the expected work information with actual work information, which is obtained by applying the embroidery design to an actual work process, and updating the expected work information with reference to results of the comparison.

11. The computer-readable recording medium according to claim 9, wherein the program stored on the computer-readable recording medium is implemented in a device which is one of a Personal Computer (PC), a smart phone, a Personal Digital Assistant (PDA), a notebook computer, a netbook computer, a tablet PC, and a mobile phone.

12. The computer-readable recording medium according to claim 10, wherein the program stored on the computer-readable recording medium is implemented in a device which is one of a Personal Computer (PC), a smart phone, a Personal Digital Assistant (PDA), a notebook computer, a netbook computer, a tablet PC, and a mobile phone.
